(19) United States
(12) Patent Application Publication
(10) Pub. No.: US 2011/0010338 A1
(43) Pub. Date: Jan. 13, 2011

(54) Distributed Database System

(76) Inventor: Shuhei Nishiyama, Urayasu (JP)

Correspondence Address: Mr. Shuhei Nishiyama, 1005 Spring - Garden 1-2-24 Todaijima, Urayasu, Chiba, 279-0001, JP

(21) Appl. No.: 12/875,157

(22) Filed: Sep. 3, 2010

Related U.S. Application Data
(63) Continuation of application No. 10/542,967, filed on Mar. 6, 2006, now abandoned.

(30) Foreign Application Priority Data
Jan. 21, 2003 (JP) 2003-12545

(51) Int. Cl. G06F 17/30

(52) U.S. Cl. 707/609; 707/E17.032

(57) ABSTRACT

This invention is a distributed database system, which comprises a plurality of database domains which include one or more databases, and each of database domains is administered by a topology administration server. This topology administration server may have information of database in the database domain, such as data dictionaries, locking information, or data integrity information at join operation, and are transformer to the other topology administration server in the other database domain on the network by peer to peer. This invention makes join overhead such as a two phases commit or replication decrease, and achieve realization of multi instance real time updatable distributed database environment.

### PRIORITY INFORMATION

This application is a continuation of U.S. patent application Ser. No. 10/542,967, filed on Mar. 6, 2006, entitled “DISTRIBUTED DATABASE SYSTEM”, which is herein incorporated by reference in its entirely, and which claims the benefit of PCT patent application PCT/JP03/14390 filed on Nov. 12.2003, which is herein incorporated by reference in its entirely, and which claims the benefit of patent application of Japan P2003-12545 filed on Jan. 21 2003 which was patented on Jul. 25, 2008 by JPO.

### BACKGROUND OF THE INVENTION

1. Field of the Invention

The present invention relates to a distributed database system and a grid computing system utilizing the distributed database system.

2. Description of the Prior Art

In a typical prior art commercialized relational database system, the data distribution is implemented by two-phase commit and by replication; a hard-disk is utilized as storage medium of the database, so that the database stops when backup is performed.

In the two-phase commit, when a change of the value of a cell or a deletion of the column of the cell in a referred table is performed among cells of the table which are normalized and have reference/referenced relationships which must keep referential integrity, (assuming that the reference tables are distributed into a plurality of database administration server computers) it is necessary to avoid causing a reference cell to refer to a non-existent referenced cell. Therefore, once a check is executed on the referenced table on the host computer, when there is no reference cell, the update is temporary committed. Nevertheless when there is no reference cell, the update is finally committed, so that it is called two-phase commit. In the multi transaction processing, two-phase commit has been required to keep consistency also.

However, the two-phase commit causes a decline in performance, and a solution thereof has been suggested by Japanese Patent Publication No. 2001-306380 (TWO-PHASE COMMITMENT EVADING SYSTEM AND ITS PROGRAM RECORDING MEDIUM), page 2-3. Abstract quotation: “PROBLEM TO BE SOLVED: To evade two-phase commitment causing the reduction of the performance of a delay type transaction processing system and to prevent the occurrence of double update of a file by transaction data or the like.

SOLUTION: In the two-phase commitment evading system of the delay type transaction processing system for delaying and executing a processing request outputted from a transaction processing program, a 1st transaction processing program 3 registers the processing request and informs a 2nd transaction processing program 12 of the identification (ID) information of the processing request and the program 12 executes the processing request when the ID information of the processing request is different from previously processed and stored ID information and reports the end of processing when all the processing is normally finished.”.

Moreover, replication is a technology for resolving the deficiency that the two-phase commit takes too long time to be put into practical use. Mainly, a master table is copied on a server to which the new transaction data is inputted, and treated as a read-only table. In the conventional network environment, the transmission rate, i.e., on ISDN or on WAN mounted by frame relay method, is not so high that it is impractical to update copies in real-time at every update of data on the original table. Therefore, since the update is executed by periodically referring to the update information from a server, which caches, it takes several minutes to synchronize the original table with the copy, thereby limiting the usage thereof.

Meanwhile, although the RAM normally used for main memory loses contents thereof when power is interrupted, it is able to input/output of data at a comparatively high speed, so that it is used for loading a program or for a temporary memory domain. In the conventional commercialized database administration system, since RAM was expensive in the past and a non-volatile memory was low-speed and expensive, a magnetic disc device, which does not lose memory in a power failure, has been mainly used as a memory medium for storing data. This affects the successor system, so that devices using a magnetic disc are still used as a memory device of a database.

In the conventional backup of a database, it is assumed that low-speed memory medium is used as a backup medium, and if backup is executed without stopping the database, it becomes impossible to maintain consistency between the updated contents and the contents before the backup. Therefore, a method of writing a snapshot of the moment on a backup medium has been used.

Moreover, in the conventional grid computing as represented by SETI@home, only the process-sharing type, which does not place a burden on network of participants, exists. This is to connect many personal computers all over the world via the internet under emergency connection by using ISDN (Integrated Service Digital Network) at maximum 128 Kbps before the broadband internet such as xDSL, FTTH, or CATV is widely used. In the process-sharing type grid-computing, a participants receives applications and data from a central computer, computing the received job in the background, and returns a result thereof to the central computer processing own job by the own computer. Therefore, not processing, in which new jobs come up frequently and result thereof are to be returned, thereby putting burden on the network of the participant; but processing, in which data and applications are inputted once from the network, are computed by the hour, and results thereof are outputted to the network, thereby putting no burden on the network of the participant is shared.

However, two-phase commit and replication require complex procedure to incorporate one computer into the distributed database system. This makes it difficult to distribute data.

Moreover, in recent years, for example, typically within a company, the inter-office LAN is established, high-performance personal computers are allocated on the workers' desks, and many high-performance personal computers are connected to the inter-office LAN. However, in these computers, word processor and spreadsheet processing program, or processing tool of presentation etc. are operated only in the daytime, therefore, CPU, memory, and disk have surplus capacity, and are not utilized effectively.

Moreover, this is not limited to a corporate environment, for example, in case of multiple occupancy dwellings with constantly-connected internet, CPU, memory, and disk thereof are not utilized effectively.

Furthermore, in cases where data is distributed, it becomes difficult to stop a database. This makes it impossible to use the conventional backup method of the database.

It is an objective of the present invention to provide a distributed database system enabling easy data distribution and effective utilization of capacities of CPU, memory, and disk of a personal computer connected to network.

### SUMMARY OF THE INVENTION

In order to resolve the aforementioned deficiencies, the present invention provides a distributed database system, which comprises:

a database administration server apparatus, which administers the database, and,

a topology administration server apparatus for administering the database of the database administration server apparatus.

In this distributed database system, the topology administration server apparatus stores topology information, including certain information correlating a database object identifier, which is information for identifying a database object administered by the database administration server apparatus, with an identifier of a database administration server apparatus for identifying a database administration server apparatus administering the database object.

Moreover, topology information may correlate an identifier for a database administration server apparatus, in which a database object is updated, with a database object identifier. The topology administration server apparatus may update the topology information in accordance with a detection of updating the database object to the database administration server apparatus.

This enables easy addition of a database administration server apparatus, which holds a database object.

Moreover, a topology administration server apparatus may store secure information on a database object.

This enables updating of data without inconsistency even if the data is distributed.

Moreover, a topology administration server apparatus may exchange topology information with other topology administration server apparatus.

This enables wide-range distribution of databases.

Moreover, in cases where a database administration server apparatus updates a database object, the information of the database object updated is transmitted to a topology administration server apparatus, and the information transmitted is transmitted to the other topology administration server apparatus and which effects to the database objects on the other database administration server apparatus.

This enables updating of data. In particular, it becomes possible to perform computation in accordance with updating of data, in cases where the computation is performed referring the database object by the computer.

Moreover, a database administration server apparatus may transmit update-operation as a journal, and a journal administration server apparatus may receive and may replay the journal.

This enables backup without stoppage of a database, thereby resolving a deficiency.

### BRIEF DESCRIPTION OF THE DRAWINGS

FIG. 1 is a schematic diagram of the present invention.

FIG. 2 is a functional block diagram of the computer of the distributed database system of the first embodiment of the present invention.

FIG. 3 is a functional block diagram of the topology administration server apparatus 401 of the first embodiment of the present invention.

FIG. 4 is a functional block diagram of the distributed database system of the second embodiment of the present invention.

FIG. 5 is a functional block diagram of the journal administration server apparatus of the second embodiment of the present invention.

FIG. 6 is a functional block diagram of the database administration server apparatus of the second embodiment of the present invention.

### DESCRIPTION OF THE PREFERRED EMBODIMENT

Hereinafter, the embodiments of the present invention will be described by referring to the drawings. The present invention will not be limited to these embodiments and may be embodied in various forms without departing from the essential characteristics thereof.

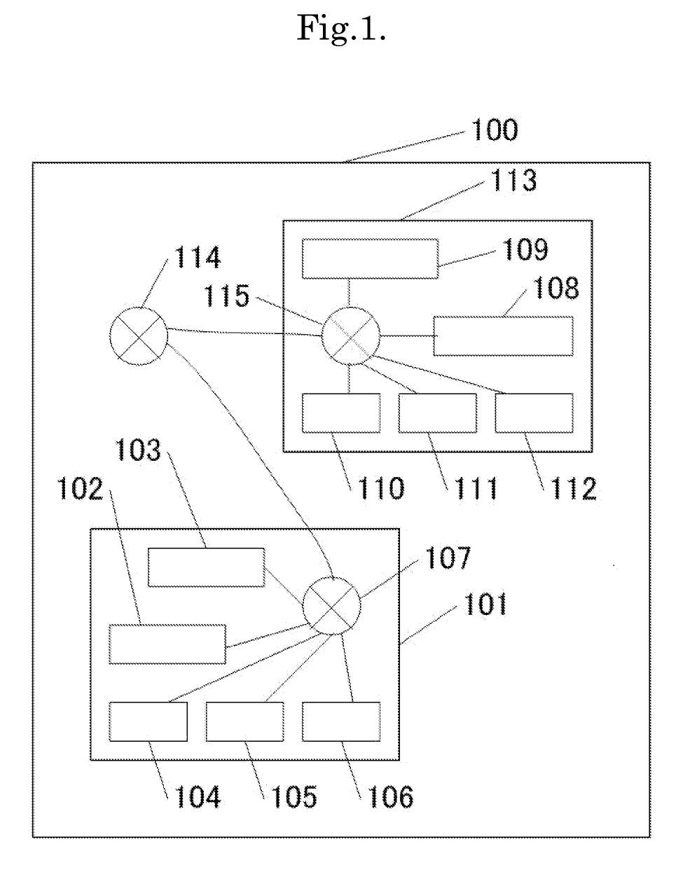

FIG. 1 is a schematic diagram of the present invention. The distributed database system (100) comprises two or more administration domains (101, 113) relate to a distributed database system of the present invention. For example, the administration domain (101) comprises a database administration server apparatus (102), a topology administration server apparatus (103), and a plurality of client computers (104, 105, . . . , and 106); and the router (107) being adapted to establish communication among them.

The access request for accessing the database object administered by the database administration server apparatus (102) is transmitted from the computer (104, 105, . . . , and 106) to the topology administration server apparatus (103).

The topology administration server apparatus (103) transfer the access request to the database administration server apparatus (102), and, in accordance with this, the database administration server apparatus transmits the database object to the client computer, which has transmitted the access request, and the client computer becomes able to access the database object.

Moreover, as shown in FIG. 1, there may be a plurality of the administration domain. In this case, a plurality of the administration domain is connected via the communication network (114). In such case, The topology administration server apparatus (103) of the administration domain (101) and the topology administration server apparatus (109) of the administration domain (113) communicate with each other, and exchange information relating to the database object stored in the database administration server apparatus of the distributed database system therein. For example, the topology administration server apparatus (103) transmits information relating to the database object stored by the database administration server apparatus (102) to the topology administration server apparatus (109).

For example, the client computer (110) of the administration domain (113) transmits the access request of the database object administered by the database administration server apparatus (102) to the topology administration server apparatus (109), so that, the topology administration server apparatus (109) detects the existence of the required database object in the database administration server apparatus (102) of the administration domain (101), and transfer the cache request to the topology administration server apparatus (109).

Note that, for the topology administration server apparatus, the distributed database system, to which the client computer transmitting the access request to the topology administration server apparatus belongs, may be called an “administration domain” or “topology domain”.

Moreover, the topology administration server apparatus may administer a lock operation to the database object.

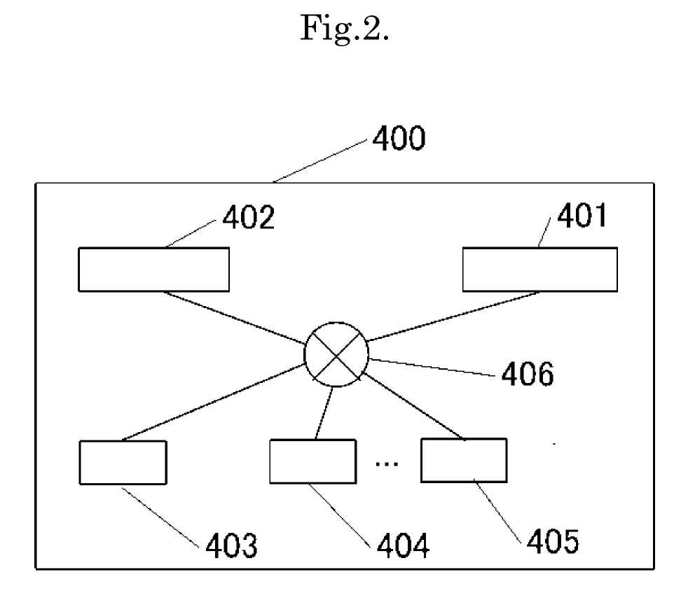

FIG. 2 is a functional block diagram of the distributed database system of the first embodiment of the present invention. The administration domain (400) of the first embodiment comprises the database administration server apparatus (402), the topology administration server apparatus (401), and a plurality of client computers (403, 404, . . . , and 405).

The “database administration server apparatus” (402) administers database allocated on the network. Note that the databases allocated on the network may include the database stored in the database administration server apparatus (402).

The “topology administration server apparatus” (401) is an apparatus, which shares the data of the database administration server apparatus (402) in the other administration domain by exchanging the topology information with the other topology administration server apparatus in the other administration domain.

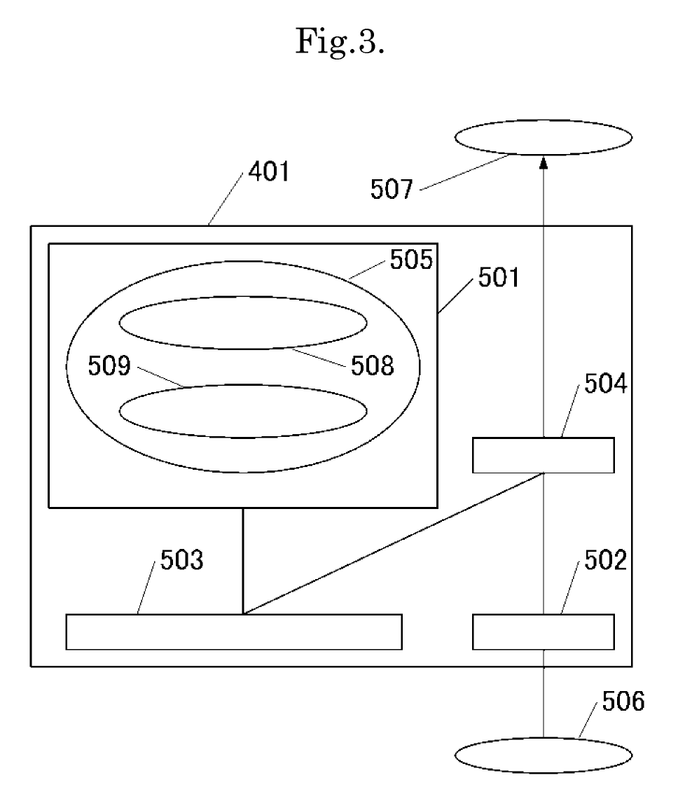

FIG. 3 is a functional block diagram of the topology administration server apparatus (401). the topology administration server apparatus (401) comprises storage for topology information (501), a receiver for access request (502), an acquisition unit for an identifier of database administration server apparatus (503), and a transferring unit for an access request (504).

The “storage for topology information” (501) stores the topology information. The “topology information” corresponds to information including information, which correlates the database object identifier and the identifier of database administration server apparatus. The “database object identifier” corresponds to information for identifying the database object administered by the database administration server apparatus (402). The “information” above may be called “database dictionary”. Examples of the database object include: (1) database itself, (2) respective tables, which configure the database, (3) the index attached to the column of the table, (4) respective rows, which configure the table, and (5) respective columns, which configure the row. Therefore, examples of the database object identifier include: the database identifier, the table identifier, the index identifier, the line identifier, and the column identifier. The “identifier of database administration server apparatus” corresponds to the data dictionary information for identifying the database administration server apparatus, which administers the database object. For example, in cases where the database administration server apparatus is identified by name, the name is the identifier of database administration server apparatus, or for example, by an IP address, the IP address is the identifier of database administration server apparatus.

The topology information includes information, which correlates the database object identifier and the identifier of database administration server apparatus. Consequently, the storage for topology information (501) may store the topology information, for example, by a table having a column comprising the database object identifier and the identifier of database administration server apparatus. Moreover, in order to acquire an identifier of database administration server apparatus from a database object identifier; an index, in which the database object identifier is a key and the identifier of database administration server apparatus is a value, may be used.

The “receiver for cache request” receives an access request. The “access request” corresponds to information including a database object identifier transmitted from at least one or more client computers in order to cache the database object identified by the database object identifier.

The “acquisition unit for an identifier of database administration server apparatus” (503) acquires a corresponding identifier of a database administration server apparatus from the storage for topology information (501) based on the database object identifier included in the access request received by the receiver for an access request (502). For example, in cases of an index in which the database object identifier is a key and the identifier of database administration server apparatus is a value; by using the index, the identifier of database administration server apparatus is acquired.

The “transferring unit for access request” (504) transfers said access request to the database administration server apparatus identified by the identifier of the database administration server apparatus, in which the identifier is acquired by the acquisition unit for an identifier of a database administration server apparatus (503).

Note that, the database administration server apparatus, the topology administration server apparatus, and the client computer are implemented by a computer apparatus. In this case, one or more, or all of the computers, which implements the database administration server apparatus, the topology administration server apparatus, and the computer, may not use a magnetic disk apparatus, which includes a moving mechanism such as a rotational axis. This configuration, in which there is no mechanical factor, improves reliability of the computer apparatus, thereby improving reliability of the entire system. Moreover, without using a magnetic disk, it becomes unnecessary for the operating system operating on the computer apparatus to have a file system, thereby enabling maximum effective use of resource thereof. Furthermore, a uninterruptible power supply, which is able to supply power for some time during power outage, may be connected to the computer apparatus, thereby further improving the reliability thereof.

In the second embodiment, the distributed database system, in which backup is executed without stopping the database, and in case of failure, a recovery is possible. For this purpose, the update journal generated by the database administration server apparatus is transmitted to the physically different server connected to network.

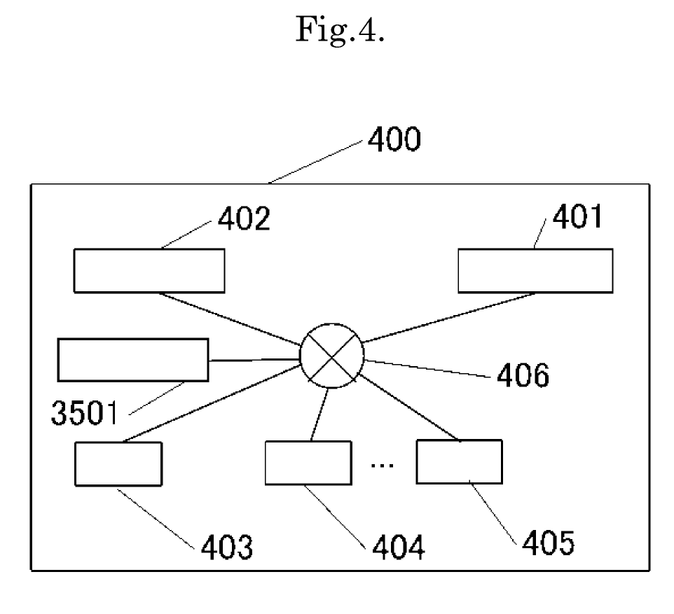

FIG. 4 is a functional block diagram of the distributed database system of the second embodiment. The distributed database system is the distributed database system according to the first embodiment, which comprises a journal administration server apparatus (3501).

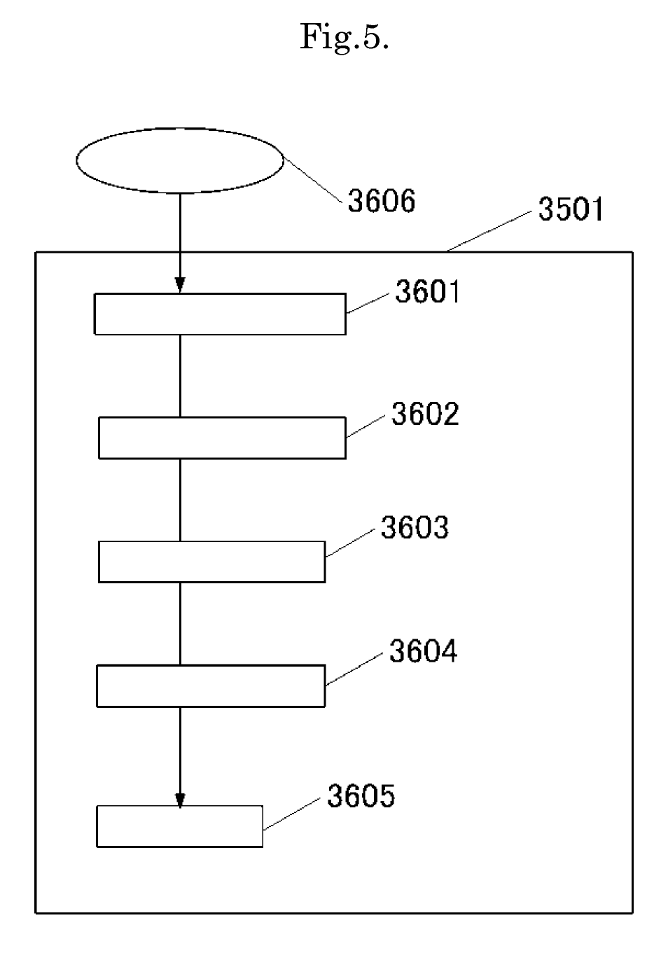

FIG. 5 is a functional block diagram of the Journal administration server apparatus (3501). The Journal administration server apparatus (3501) comprises a receiver for journal (3601), storage for journal (3602), a replay unit for journal (3603), a storing unit for snapshot (3604), and a recovery unit (3605).

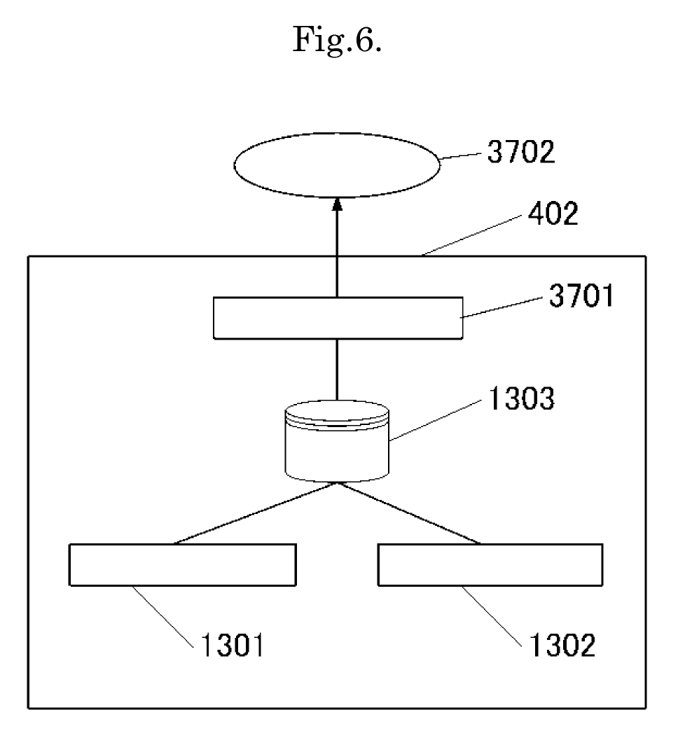

FIG. 6 is a functional block diagram of the distributed database system of the second embodiment, the distributed database system according to the first embodiment, which comprises a transmitter for journal (3701).

The “receiver for a journal” (3601) receives a journal. The “journal” corresponds to information indicating an update to the database object administered by the database administration server apparatus. Therefore, the information is information indicating what update-operation is executed to the database object in the database administration server apparatus. The journal may be generated with respect to each update-operation, or may be generated with respect to each one or more update-operations, at the timing that a transaction is committed, etc.

The “storage for a journal” (3602) stores the journal received by the receiver for journal (3601), for example, into memory, magnetic disk, or optical disk, etc. Alternatively, if the power supply is reliable, the journal may be stored in main memory.

The “replay unit for a journal” (3603) replays the journal stored by the storage for a journal (3602). The “replay” means that the update-operation to the database object indicated by the journal is executed by the Journal administration server apparatus (3501). The replay of the journal is executed to the snapshot stored by the storing unit for snapshot (3604).

This replay may be executed with respect to each storage for the journal by the storage for a journal (3602). Alternatively, the replay may be executed when more than a predetermined amount of the journal is stored by the journal by the storage for journal (3602). Alternatively, the replay may be executed at each predetermined time.

The “storing unit for a snapshot” (3604) stores the snapshot generated based on the journal replayed by the replay unit for a journal (3603).

By replaying the journal, the database administrated by the database administration server apparatus is reproduced by the Journal administration server apparatus. The “snapshot” corresponds to a copy at one point of the database reproduced in such manner. Such copy is memorized and stored, for example, by a memory, a magnetic disk, an optical disk etc. Moreover, the replayed journal may be deleted from the storage for journal 3602 with respect to each storage for the snapshot.

Moreover, a plurality of snapshots may be stored. For example, more than two snapshots such as (1) a snapshot before a specific journal is replayed, (2) a snapshot after a specific journal is replayed etc. are may be stored.

The “recovery unit” (3605) has a function for executing processes for recovery of a domain in failure from said snapshot upon suffering a domain failure. An example of “suffering a domain failure” includes a failure of the database administration server apparatus of the distributed database system. The “domain in failure” corresponds to a domain suffering from failure. The “processes for recovery” corresponds to processes for recovery from the failure. For example, the snapshot stored in the storing unit for snapshot is transmitted to the database administration server apparatus, and the journal, which has been stored by the storage for a journal after the snapshot has been stored by the storing unit for snapshot, is replayed by the database administration server apparatus. Alternatively, with regard to the snapshot stored in the storing unit for a snapshot, the snapshot, which is acquired by replaying the journal, which has been stored by the storage for a journal after the snapshot has been stored by the storing unit for a snapshot, is transmitted to the database administration server apparatus. Alternatively, a new database administration server apparatus is prepared, and the snapshot may be transmitted to the database administration server apparatus.

The “transmitter for a journal” (3701) transmits the journal. Therefore, information indicating what update-operation is executed to the database object in the database object administration apparatus 402 is transmitted. This transmission may be executed with respect to each execution of update-operation to the database object. Alternatively, the transmission may be executed with respect to each occurrence of a predetermined event such as commitment of transaction.

In the present invention, it is assumed to use the database in the enterprise system, so that it is difficult to stop the database, according to the second embodiment, it becomes possible to backup the database without stopping the database. Moreover, the recovery from failure is executed by moving the snapshot, thereby finishing the recovery in a short time.

Furthermore, it becomes possible to deal with data loss on the main memory caused by failure of hardware such as the database administration server apparatus etc. or restart for hang-up of software etc. The recovery is completed in a limited domain, so that a recovery of massive database is completed in the distributed object, thereby reducing operational burden.

Hereinafter, the example of the present invention will be described.

The work stations or personal computers, which are allocated in the company, are connected to LAN. The personal computers on the employees' desks are used during working hours, however, not used during the night time and holiday. Although these personal computers are high-performance, software working thereon are word processor, spreadsheet, presentation processing tool, mailer, browser, etc., which don't require so much computational resource, thereby producing capacity surpluses of CPU, main memory, and magnetic disk thereof.

Meanwhile, since monthly processing of payment requesting and receiving concentrates at the month-end, in order to use the capacity surpluses of the personal computers, these computers are used as computers of the distributed database system of the present invention. In this case, a computer, of which computational load is below a predetermined level, is caused to cache the database object for the processing of payment requesting and receiving, and to operate the program for processing of payment requesting and receiving referring the database object. Accordingly, it becomes possible to execute processing of payment requesting and receiving without support of work station, etc.

Moreover, another example of the present invention will be described, hereinafter.

Assuming that a company, which provides the broadband internet service to a multi-dwelling such as an apartment house, decides not to collect the service usage fee, in order to make all the apartments of the multi-dwelling use the service. Instead, they offer the condition that high-performance personal computers with low-power consumption are provided to all the houses, and are always on. Of course, always-on connection to the broadband internet as a condition is also required.

Assuming that the provided high-performance personal computer with low-power consumption is the computer of the distributed database system of the present invention. This high-performance personal computer may be a computer, which does not include a magnetic disk apparatus, which includes a moving mechanism such as a rotational axis, thereby reducing occurrence of mechanical failure. Moreover the computer may be connected to a uninterruptible power supply preparing for power outage. A company, which provides the broadband internet service, makes a contract with a company, which needs computer resources, and provides the surplus computer resources of the high-performance personal computer with low-power consumption provided to all the apartments collectively. The usage fee of this surplus computer resource is collected by the company providing the broadband internet service from the company having the contract. Moreover, by operating software of the groupware using the database object on the personal computer of the each apartment, the groupware environment in the apartment house and a regional information network are implemented.

By exchanging the topology information among the topology administration server apparatuses, of which domains are the apartment house, the regional information network develops and increases the value thereof as a market resource.

As described above, according to the distributed database system of the present invention, it becomes possible to distribute the database object to a plurality of computers. Moreover, it becomes possible to execute distributed computation with effective utilization of CPU resources and memory resources. Furthermore, it becomes possible to backup the database without stopping the database. Therefore, the present invention is effective as a distributed database system.

### REFERENCE NUMERALS

100 Distributed database system
101, 113 Administration domains
102, 108 Database administration server apparatus
103, 109 Topology administration server apparatus
104, 105, 106 Client Computer
107, 115 Router
110, 111, 112 Client Computer
114 Communication network
400 Administration domain
401 Topology administration server apparatus
402 Database administration server apparatus
403, 404, 405 Client computers
406 Router
501 Topology information
502 Receiver for access request
503 Identifier of database administration server apparatus
504 Transferring unit for an access request
505 Storage for topology information
506, 507 Access request
508 Data object identifier
509 Identifier of database administration server apparatus
1301 Receiver for access request
1302 Copy and transmission unit
1303 Database
3501 Journal administration server apparatus
3601 Receiver for journal
3602 Storage for journal
3603 Replay unit for journal
3604 Storing unit for snapshot
3605 Recovery unit
3606 Journal
3701 Transmitter for journal
3702 Journal

1. A distributed database system comprising
two or more administration domains
which are sited on network/networks and connected to communicate each other,
wherein said administration domain comprising:
one or more topology administration server apparatus/apparatuses,
and one or more database administration server apparatus/apparatuses;
wherein said topology administration server apparatus/apparatuses comprising:
one or more storage/storages for topology information,
and one or more exchanging unit/units for topology information;
wherein said topology administration servers exchange their topology information each other,
wherein said database administration server apparatus administers database/databases which is/are allocated on said database administration server apparatus.
wherein said topology information including such as:
database dictionary,
locking status,
and referential integrity status;
wherein said database dictionary including certain information correlating database objects and identifying a database object with an identifier of the said database object administered by said database administration apparatus/apparatuses;

2. The distributed database system of claim 1, wherein said topology information further more including such as management information for multi transactions commitment.

3. The distributed database system of claim 1, wherein said topology information further more including such as information mapping group ID of rows partitioned horizontally from one relation which should be sited in the database to physical node locations.

4. The distributed database system of claim 2, wherein said topology information further more including such as information mapping group ID of rows partitioned horizontally from one relation which should be sited in the database to physical node locations.

5. The distributed database system of claim 1, wherein said topology information further more including such as information mapping group ID of columns partitioned vertically from one relation which should be sited in the database to physical node locations.

6. The distributed database system of claim 2, wherein said topology information further more including such as information mapping group ID of columns partitioned vertically from one relation which should be sited in the database to physical node locations.

7. The distributed database system of claim 1, wherein said exchanging unit/units for topology information comprising such as:
one or more receiver/receivers to receive the topology information updated on the other topology administration server apparatus/apparatuses,
and one or more transferring unit/units to transfer the topology information into the other topology administration server apparatus/apparatuses.

8. The distributed database system of claim 2, wherein said exchanging unit/units for topology information comprising such as:
one or more receiver/receivers to receive the topology information updated on the other topology administration server apparatus/apparatuses,
and one or more transferring unit/units to transfer the topology information into the other topology administration server apparatus/apparatuses.

9. The distributed database system of claim 7, wherein said topology information further more including such as information mapping group ID of rows partitioned horizontally from one relation which should be sited in the database to physical node locations.

10. The distributed database system of claim 8, wherein said topology information further more including such as information mapping group ID of rows partitioned horizontally from one relation which should be sited in the database to physical node locations.

11. The distributed database system of claim 7, wherein said topology information further more including such as information mapping group ID of columns partitioned vertically from one relation which should be sited in the database to physical node locations.

12. The distributed database system of claim 8, wherein said topology information further more including such as information mapping group ID of columns partitioned vertically from one relation which should be sited in the database to physical node locations.
